(19) United States
(12) Patent Application Publication
(10) Pub. No.: US 2026/0360688 A1
(43) Pub. Date: Nov. 12, 2026

(54) ELECTRODE PLATE, AND METHOD OF MANUFACTURING, ELECTRODE ASSEMBLY, AND RECHARGEABLE LITHIUM BATTERY INCLUDING THE SAME

(71) Applicant: Samsung SDI Co., Ltd., Yongin-si (KR)

(72) Inventor: Sungsu Kim, Yongin-si (KR)

(73) Assignee: Samsung SDI Co., Ltd., Yongin-si (KR)

(21) Appl. No.: 19/671,543

(22) Filed: May 8, 2026

(30) Foreign Application Priority Data
May 12, 2025 (KR) 10-2025-0061417

(51) Int. Cl. H01M 4/04; H01M 4/02

(52) U.S. Cl. CPC H01M 4/0404; H01M 2004/021

(57) ABSTRACT

An electrode plate for a lithium rechargeable battery includes an electrode substrate, a first active material layer formed by coating a first active material forwardly from a first start end on the electrode substrate, and a second active material layer formed on the first active material layer by coating a second active material frontwardly from a second start end disposed at a distance rearwardly by a predetermined section from the first start end in a proceeding direction of the coating.

### CROSS-REFERENCE TO RELATED APPLICATION

This present application claims priority to and the benefit under 35 U.S.C. § 119(a)-(d) of Korean Patent Application No. 10-2025-0061417, filed on May 12, 2025, in the Korean Intellectual Property Office, the entire disclosure of which is incorporated herein by reference.

### BACKGROUND

### Field

The present disclosure relates to an electrode plate for a lithium rechargeable battery, a manufacturing method of the electrode plate, and an electrode assembly and a lithium rechargeable battery including the electrode plate.

### Description of the Related Art

Recently, with the rapid proliferation of electronic devices using batteries, such as mobile phones, notebook computers, and electric vehicles, demand for rechargeable batteries having high energy density and high capacity has rapidly increased. Accordingly, research and development for improving the performance of lithium rechargeable batteries have been actively conducted.

A lithium rechargeable battery is a battery including a positive electrode and a negative electrode, each including an active material capable of intercalation and deintercalation, and an electrolyte, and produces electrical energy by oxidation and reduction reactions occurring when lithium ions are intercalated into and deintercalated from the positive electrode and the negative electrode.

A manufacturing process of a lithium rechargeable battery includes an electrode plate process, an assembly process, and a formation process. The electrode plate process for manufacturing an electrode of a lithium rechargeable battery includes a coating process of forming a positive electrode and a negative electrode by applying an active material and an insulating material to a surface of an electrode substrate, a roll-press process of pressing the coated electrode, and a slitting process of cutting the pressed electrode according to dimensions.

In the coating process, the active material may be continuously coated on the electrode substrate or may be intermittently pattern-coated, and the coated active material layer may be formed as a single layer or multiple layers. When the coating layer is formed in a pattern, a rising phenomenon of the coating layer may occur at a coating start point. In addition, when a plurality of coating layers are formed in a pattern, the rising phenomenon may become more significant due to overlapping rising of the plurality of coating layers at the coating start point.

### SUMMARY

An electrode plate for a lithium rechargeable battery according to embodiments includes: an electrode substrate; a first active material layer formed by coating a first active material forwardly from a first start end on the electrode substrate; and a second active material layer formed on the first active material layer by coating a second active material frontwardly from a second start end disposed at a distance rearwardly by a predetermined section from the first start end in a proceeding direction of the coating.

A lithium rechargeable battery electrode assembly according to embodiments includes the electrode plate for a lithium rechargeable battery.

A lithium rechargeable battery according to embodiments includes the electrode plate for a lithium rechargeable battery.

A method for manufacturing an electrode plate for a lithium rechargeable battery according to embodiments includes: a first step in which a first active material layer is formed by coating a first active material frontwardly from a first start end on an electrode substrate; a second step in which a second active material layer is formed on the first active material layer by a second active material from a second start end disposed rearwardly from the first start end in a proceeding direction of the coating; and pressing the first active material layer and the second active material layer.

According to embodiments, a second start end of a second active material layer distanced rearwardly by a section from a first start end of a first active material layer in a proceeding direction of coating is disposed, and the second active material layer is formed on the first start end and the first active material layer such that a phenomenon of rising of a coating layer in the vicinity of the first and second start ends of the first and second active material layers can be minimized and prevented.

### BRIEF DESCRIPTION OF THE DRAWINGS

FIG. 1 is a partial cross-sectional view of a state before pressing an electrode plate for a rechargeable battery according to embodiments of the present disclosure.

FIG. 2 is a flowchart of a method for manufacturing an electrode plate for a rechargeable battery according to embodiments of the present disclosure.

FIG. 3 is a cross-sectional view of the distribution of graphite particles included in the first active material layer and the second active material layer in the electrode plate for a lithium rechargeable battery of FIG. 1.

FIG. 4 is a cross-sectional view of the distribution of graphite particles included in the first active material layer and the second active material layer in a pressed state of the electrode plate for a lithium secondary battery of FIG. 1.

FIG. 5 is a cross-sectional view of the distribution of graphite particles included in a first active material layer and a second active material layer in an electrode plate for a lithium rechargeable battery according to a comparative example.

FIG. 6 is a cross-sectional view of the distribution of the graphite particles included in the first active material layer and the second active material layer in a state that the electrode plate for a lithium rechargeable battery of FIG. 5 is pressed.

FIG. 7 to FIG. 10 are schematic diagrams of a lithium rechargeable battery according to embodiments.

### DETAILED DESCRIPTION

Hereinafter, embodiments of the present disclosure will be described in detail. However, this is disclosed by way of example only, and the present disclosure is not limited thereto, but is defined only by the scope of the claims set forth herein.

Unless otherwise specified herein, when a part such as a layer, film, region, or plate is described as being “on” another part, this includes not only a case in which the part is directly on the other part, but also a case in which another part is interposed therebetween.

Unless otherwise specified herein, the singular form may include the plural form. In addition, unless otherwise specified, “A or B” may mean including A, including B, or including both A and B.

As used herein, “a combination thereof” may refer to, for example, a mixture, laminate, composite, copolymer, alloy, blend, or reaction product of constituent materials.

Unless otherwise defined herein, a particle diameter may refer to an average particle diameter. In addition, the particle diameter may refer to an average particle diameter D50, which means a particle diameter at which the cumulative volume in the particle size distribution is 50 vol %. The average particle diameter D50 may be measured by a method widely known to those skilled in the art, and may be measured, for example, using a particle size analyzer, or from a transmission electron microscope (TEM) image or a scanning electron microscope (SEM) image. Alternatively, the average particle diameter D50 may be obtained by using a measuring apparatus based on dynamic light scattering, performing data analysis, counting the number of particles for each particle size range, and calculating the average particle diameter D50 therefrom. Alternatively, the average particle diameter may be measured by a laser diffraction method. More specifically, when measured by the laser diffraction method, particles to be measured may be dispersed in a dispersion medium and then introduced into a commercially available laser diffraction particle size measuring apparatus, for example, an MT 3000 manufactured by Microtrac, followed by irradiation with ultrasonic waves at about 28 kHz with an output of 60 W, and the average particle diameter D50 at the 50% point of the particle size distribution in the measuring apparatus may be calculated.

Embodiments provide an electrode plate for a lithium rechargeable battery, which minimizes a phenomenon of rising in a coating layer in the vicinity of a start end where coating of an active material starts. Embodiments provide an electrode plate for a lithium rechargeable battery, which minimizes a phenomenon of rising in a coating layer in the vicinity of a start end where coating of an active material starts when the coating layer is formed in a pattern. Embodiments provide an electrode plate for a lithium rechargeable battery, which minimizes a phenomenon of rising in a coating layer in the vicinity of a start end where coating of an active material starts when the coating layer is provided in plurality and formed in a pattern.

Embodiments provide a method for manufacturing the electrode plate for a lithium rechargeable battery.

Embodiments provide an electrode assembly for a lithium rechargeable battery, including the electrode plate, and a lithium rechargeable battery.

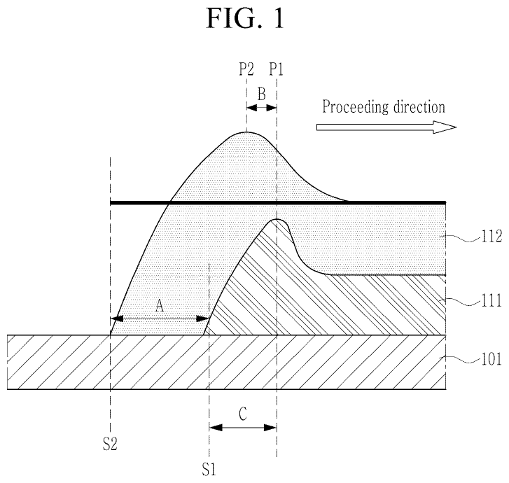

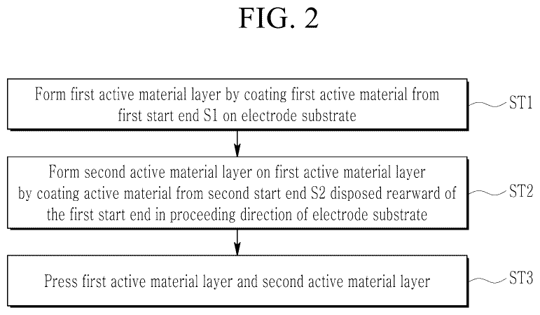

FIG. 1 is a partial cross-sectional view of a state before pressing an electrode plate for a rechargeable battery according to embodiments of the present disclosure, and FIG. 2 is a flowchart of a method for manufacturing an electrode plate for a rechargeable battery according to embodiments of the present disclosure.

Referring to FIG. 1 and FIG. 2, an electrode plate for a lithium rechargeable battery electrode plate according to embodiments includes an electrode substrate 101 and a plurality of active material layers provided in the electrode substrate 101. As an example, the active material layer includes a first active material layer 111 and a second active material layer 112, and although it is not illustrated, three or four active material layers may be formed.

In addition, although one electrode plate is exemplarily described, the electrode plate in the lithium rechargeable battery includes a positive electrode and a negative electrode. In the positive electrode and the negative electrode, the electrode substrate 101 is a current current collector, active material layers respectively include a positive electrode active material and a negative electrode active material. The current current collector may be formed as an aluminum or copper sheet.

### Positive Electrode Active Material

A positive electrode active material, a compound capable of reversible intercalation and deintercalation of lithium (a lithiated intercalation compound) may be used. Specifically, one or more of composite oxides of lithium and a metal selected from cobalt, manganese, nickel, and a combination thereof may be used.

The composite oxide may be a lithium transition metal composite oxide, and a specific example may include a lithium nickel-based oxide, a lithium cobalt-based oxide, a lithium manganese-based oxide, a lithium iron phosphate compound, a cobalt-free nickel-manganese-based oxide, or a combination thereof.

For example, a compound expressed by any one of the following chemical formula may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the herein chemical formula, A denotes Ni, Co, Mn, or a combination thereof; X denotes Al, Ni, Co, Mn, Cr, Fe, Mg, Sr, V, a rare-earth element or a combination thereof; D denotes O, F, S, P, or a combination thereof; G denotes Al, Cr, Mn, Fe, Mg, La, Ce, Sr, V, or a combination thereof; L¹ denotes Mn, Al, or a combination thereof.

For example, the positive electrode active material may be a high-nickel-based positive electrode active material in which, in a lithium transition metal composite oxide, the nickel content is 80 mol % or more, 85 mol % or more, 90 mol % or more, 91 mol % or more, or 94 mol % or more and 99 mol % or less, based on 100 mol % of metals excluding lithium. The high-nickel-based positive electrode active material can implement a high capacity and thus may be applied to a high-capacity and high density lithium rechargeable battery.

### Positive Electrode

A positive electrode plate for a lithium rechargeable battery may include a current current collector and a positive electrode active material layer formed on the current current collector. The positive electrode active material layer may include a positive electrode active material, and may further include a binder and/or a conductive material.

For example, the positive electrode may further include an additive that can serve as a sacrificial positive electrode.

The content of the positive electrode active material may be 90 wt % to 99.5 wt % with respect to 100 wt % of the positive electrode active material layer, and the content of the binder and the content of the conductive material may be respectively 0.5 wt % to 5 wt % with respect to 100 wt % of the positive electrode active material layer.

The binder serves to firmly bind positive electrode active material particles to each other, and to securely bind the positive electrode active material to the current current collector. A representative example of the binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, and the like, but this is not restrictive.

The conductive material is used to impart conductive to the electrode, and any electron-conductive material may be used as long as it does not cause a chemical change in the battery in which it is used. An example of the conductive material may include a carbon-based material such as natural graphite, artificial graphite, carbon black, acetylene black, Ketjen black, carbon fiber, carbonnanofiber, carbon nanotube, and the like; a metal-based material containing copper, nickel, aluminum, silver, and the like and having a metal powder or metal fiber form; a conductive polymer such as a polyphenylene derivative and the like; or a mixture thereof.

AI may be used as the current current collector, but it is not limited thereto.

### Negative Electrode Active Material

The negative electrode active material includes a material capable of reversibly intercalating and deintercalating lithium ion, a lithium metal, an alloy of lithium metal, a material capable of doping and dedoping lithium, or a transition metal oxide.

As a material that can reversibly intercalate and deintercalated the lithium ion may include a carbon-based negative electrode active material, for example, crystalline carbon, amorphous carbon, or a combination thereof. An example of the crystalline carbon include graphite such as natural graphite or artificial graphite having an amorphous, plate-like, flake, spherical, or fiber shape, and an example of the amorphous carbon may include soft carbon or hard carbon, mesophase pitch carbide, and calcined coke.

As the alloy of lithium metal, an alloy of lithium with a metal selected from Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si-based negative electrode active material or a Sn-based negative electrode active material may be used. The Si-based negative electrode active material may be silicon, a silicon-carbon composite, SiOx (0<x<2), a Si—Q alloy (where Q is selected from an alkali metal, an alkaline-earth metal, a group 13 element, a group 14 element (excluding Si), a group 15 element, a group 16 element, a transition metal, a rare-earth element, and a combination thereof), or a combination thereof. The Sn-based negative electrode active material may be Sn, SnO₂, an Sn-based alloy, or a combination thereof.

The silicon-carbon composite may be a composite of silicon and amorphous carbon. According to embodiments, the silicon-carbon composite may include a silicon particle and amorphous carbon coated on a surface of the silicon particle. For example, it may include a secondary particle (a core) in which silicon primary partical is assembled, and an amorphous carbon coating layer (a shell) disposed on a surface of the secondary particle. The amorphous carbon may also disposed between the silicon primary particles, and for example, the silicon primary particle may be coated with amorphous carbon. The secondary particle may be dispersed in an amorphous carbon matrix.

The silicon-carbon composite may further include crystalline carbon. For example, the silicon-carbon composite may include a core including crystalline carbon and a silicon particle, and an amorphous carbon coating layer disposed on a surface of the core.

The Si-based negative electrode active material or the Sn-based negative electrode active material may be mixed with a carbon-based negative electrode active material and used.

### Negative Electrode

An electrode plate for a lithium rechargeable batterynegative electrode includes a current collector and a negative electrode active material layer disposed on the current collector. The negative electrode active material layer includes a negative electrode active material, and may further include a binder and/or a conductive material.

For example, the negative electrode active material layer may include 90 wt % to 99 wt % of the negative electrode active material, 0.5 wt % to 5 wt % of a binder, and 0 wt % to 5 wt % of the conductive material.

The binder serves to firmly bind negative electrode active material particles to each other, and to securely bind the negative electrode active material to the current current collector. As the binder, a non-aqueous binder, an aqueous binder, a dry binder, or a combination thereof may be used.

The non-aqueous binder may include polyvinyl chloride, carboxylated polyvinyl chloride, polyvinyl fluoride, an ethylene-propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acryl rubber, butyl rubber, fluorine rubber, polyethylene oxide, polyvinylpyrrolidone, polyepichlorohydrin, polyphosphazene, poly(meth)acrylonitrile, ethylene-propylene-diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the negative electrode binder, a cellulose-based compound capable of imparting viscosity may be further included. As the cellulose-based compound, one or more of carboxymethyl cellulose, hydroxypropyl methyl cellulose, methyl cellulose, and alkali metal salt thereof may be used in combination. As the alkali metal, Na, K, or Li may be used.

The dry binder may be a polymer material capable of being fibrized, and may include, for example, polytetrafluoroethylene, polyvinylidene fluoride, a polyvinylidene fluoride-hexafluoropropylene copolymer, polyethylene oxide, or a combination thereof.

The conductive material is used to impart conductive to the electrode, and any electron-conductive material may be used as long as it does not cause a chemical change in the battery in which it is used. A detailed example of the conductive material may include a carbon-based material such as natural graphite, artificial graphite, carbon black, acetylene black, Ketjen black, carbon fiber, carbonnanofiber, carbon nanotube, and the like; a metal-based material containing copper, nickel, aluminum, silver, and the like and having a metal powder or metal fiber form; a conductive polymer such as a polyphenylene derivative and the like; or a mixture thereof.

The negative electrode current collector may include, for example, a copper foil, a nickel foil, a stainless steel foil, a titanium foil, a nickel foam, a copper foam, a polymer substrate coated with a conductive metal, or a combination thereof.

### Electrolyte

An electrode plate for a lithium rechargeable batteryelectrolyte includes a non-aqueous organic solvent and a lithium salt.

The non-aqueous organic solvent serves as a medium for migration of ions involved in an electrochemical reaction of the battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include, for example, dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and the like.

The ester-based solvent may include, for example, methyl acetate, ethyl acetate, n-propyl acetate, dimethyl acetate, methyl propionate, ethyl propionate, decanolide, mevalonolactone, valerolactone, caprolactone, and the like.

The ether-based solvent may include, for example, dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include, for example, cyclohexanone and the like. The alcohol-based solvent may include, for example, ethyl alcohol, isopropyl alcohol, and the like, and the aprotic solvent may include, for example, nitriles such as R-CN, where R is a linear, branched, or cyclic hydrocarbon group having 2 to 20 carbon atoms and may include a double bond, an aromatic ring, or an ether group; amides such as dimethylformamide; dioxolanes such as 1,3-dioxolane and 1,4-dioxolane; sulfolanes such as sulfolane; and the like.

The non-aqueous organic solvent may be used alone or in a mixture of two or more kinds.

When a carbonate-based solvent is used, a cyclic carbonate and a chain carbonate may be mixed and used, and the cyclic carbonate and the chain carbonate may be mixed in a volume ratio of 1:1 to 1:9.

The lithium salt is dissolved in the organic solvent and serves as a source of a lithium ion in the battery, thereby enabling the basic operation of the lithium secondary battery and facilitating the movement of the lithium ion between the positive electrode and the negative electrode. A representative example of the lithium salt may include one or more selected from a group consisting of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI)), LiC₄F₉SO₃, LiN(CₓF₂ₓ₊₁SO₂)(C_{y}F_{2y+1}SO₂) (where x and y are each an integer from 1 to 20), lithium trifluoromethanesulfonate, lithium tetrafluoroethanesulfonate, lithium difluorobis(oxalato)phosphate (LiDFOB), and lithium bis(oxalato)borate (LiBOB).

### Separator

Depending on the type of the lithium secondary battery, a separator may be provided between the positive electrode and the negative electrode. As such a separator, a polyethylene film, a polypropylene film, a polyvinylidene fluoride film, or a multilayer film including two or more layers thereof may be used, and a mixed multilayer film such as a polyethylene/polypropylene two-layer separator, a polyethylene/polypropylene/polyethylene three-layer separator, or a polypropylene/polyethylene/polypropylene three-layer separator may also be used.

The separator may include a porous substrate and a coating layer disposed on one surface or both surfaces of the porous substrate and including an organic material, an inorganic material, or a combination thereof.

The porous substrate may be a polymer selected from a group consisting of polyolefins such as polyethylene and polypropylene; polyesters such as polyethylene terephthalate and polybutylene terephthalate; polyacetal; polyamide; polyimide; polycarbonate; polyether ketone; polyaryl ether ketone; polyetherimide; polyamideimide; polybenzimidazole; polyethersulfone; polyphenylene oxide; cyclic olefin copolymer; polyphenylene sulfide; polyethylene naphthalate; glass fiber; Teflon; and polytetrafluoroethylene, or a polymer membrane formed of a copolymer or a mixture of two or more thereof.

The organic material may include a polyvinylidene fluoride-based polymer or a (meth)acrylic-based polymer.

The inorganic material may include, but is not limited to, an inorganic particle selected from the group consisting of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof.

The organic material and the inorganic material may be provided in a mixed form in a single coating layer, or may be provided in a laminated form in which a coating layer including the organic material and a coating layer including the inorganic material are stacked.

Hereinafter, embodiments of the present disclosure and a comparative example will be described. However, the following embodiments are merely embodiments of the present disclosure, and the present disclosure is not limited to the following embodiments.

Referring back to FIG. 1, in the electrode plate for a lithium rechargeable battery, the first active material layer 111 is formed by coating a first active material on the electrode substrate 101 using a slot die (not shown), and is formed starting from a first start end S1 on the electrode substrate 101.

The second active material layer 112 is formed on the first active material layer 111 by starting coating of a second active material from a second start end S2 disposed at a rear side distanced from the first start end S1 by a section A in the coating direction (processing from left to right in FIG. 1).

Accordingly, the second active material layer 112 is further formed than the first active material layer 111 on the first start end S1 and on the electrode substrate 101 in the section A between the first start end S1 and the second start end S2. That is, the second active material layer 112 is formed over the entire range in which the first active material layer 111 is formed when viewed based on the coating direction, and is additionally formed directly on the electrode substrate 101 in the section A where the first active material layer 111 is not formed.

Substantially, since the electrode substrate 101 proceeds while the slot die (not shown) is fixed, the coating direction is opposite to the proceeding direction of the electrode substrate 101. The electrode substrate 101 proceeds from right to left in FIG. 1.

Although not shown, the first active material layer and the second active material layer may be continuously formed. The first active material layer 111 and the second active material layer 112 are formed in an intermittent pattern. The first active material layer 111 is provided with the first start end S1 and a first peak P1, and the second active material layer 112 is provided with the second start end S2 and a second peak P2. When formed in the intermittent pattern, each pattern of first active material layer 111 and the second active material layer 112 includes a first start end S1, a second start end S2, a first peak P1, and a second peak P2.

In this case, the first peak P1 of the first active material layer 111 and the second peak P2 of the second active material layer 112 maintain a first distance B therebetween in the proceeding direction. The first distance B is formed in front of the first start end S1 in the proceeding direction. When formed in the intermittent pattern, each pattern of the first active material layer 111 and the second active material layer 112 includes the first distance B1.

The first distance B is disposed between the first start end S1 of the first active material layer 111 and the first peak P1 of the first active material layer 111. The second peak P2 of the second active material layer 112 is disposed on a second distance C set between the first start end S1 and the first peak P1 of the first active material layer 111 in the proceeding direction. When formed in the intermittent pattern, each pattern of the first active material layer 111 and the second active material layer 112 includes the second distance C.

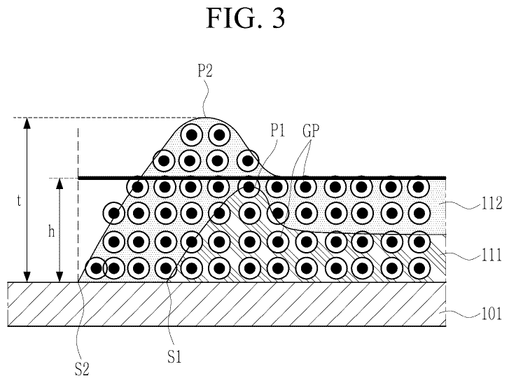

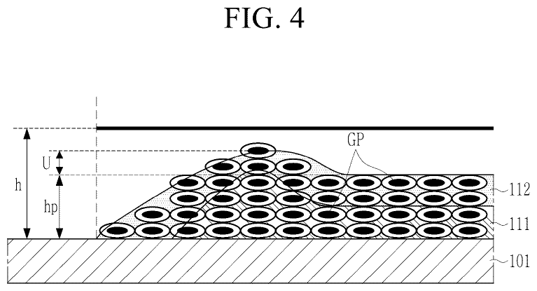

FIG. 3 is a cross-sectional view of the distribution of graphite particles included in the first active material layer and the second active material layer in the electrode plate for a lithium rechargeable battery of FIG. 1, FIG. 4 is a cross-sectional view of the distribution of graphite particles included in the first active material layer and the second active material layer in a pressed state of the electrode plate for a lithium secondary battery of FIG. 1.

Referring to FIG. 2 to FIG. 4, a method for manufacturing an electrode plate for a lithium rechargeable battery includes a first step ST1, a second step ST2, and a third step ST3. In the first step ST1, a first active material is coated from the first start end S1 on the electrode substrate 101 to form the first active material layer 111.

Referring to FIG. 2 and FIG. 3, in the second step ST2, a second active material is coated from the second start end S2 disposed rearwardly of the first start end S1 in the coating direction, thereby forming the second active material 112 on the first active material layer 111. In the second step ST2, the first active material is not coated for a period of time corresponding to a distance from the second start end S2 to the first start end S1.

For example, the slot die discharges the second active material from the second start end S2 of the electrode substrate 101 and discharges the first active material from the first start end S1 of the electrode substrate 101. That is, the slot die discharges the second active material from the second start end S2 to the first start end S1, and discharges the first active material and the second active material together at the first start end S1.

In the second step ST2, the second active material layer 112 is formed more than the first active material layer 111 on the electrode substrate 101 in the section A set between the first start end S1 and the second start end S2. That is, in the section A, only the second active material layer 112 is formed on the electrode substrate 101.

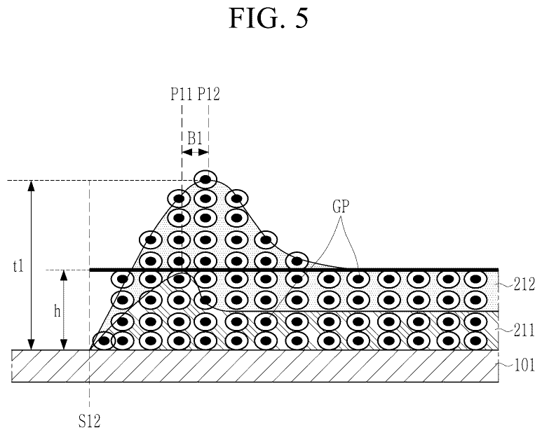

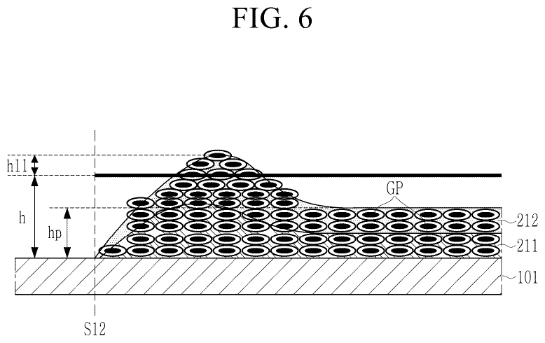

Accordingly, in the second step ST2, the first distance B is maintained between the first peak P of the first active material layer 111 and the second peak P2 of the second active material layer 112 in the coating direction. As a result, since a first peak P1 and a second peak P2 do not overlap, a thickness, which is smaller than a maximum thickness t1 (i.e., t1>t) of a first active material layer 211 and a second active material layer 212 formed when two peaks overlap (refer to comparative examples of FIG. 5 and FIG. 6) is formed (refer to FIG. 3 and FIG. 5).

The first peak P1 is formed in the first active material layer 111 of which a thickness gradually increases from the first start end S1, reaches a maximum, and then rapidly decreases to become thinner, because the first active material that had been stationary in the slot die is discharged from slot die.

The second peak P2 is formed in the second active material layer 112 of which a thickness gradually increases from the second start end S2, reaches a maximum, and then rapidly decreases to become thinner, because the second active material that had been stationary in the slot die is discharged from slot die.

In the second step ST2, the second peak P2 of the second active material layer 112 is disposed on the second distance C formed between the first start end S1 and the first peak P1 of the first active material layer 111 in the coating direction. Thus, the maximum thickness t of the first active material layer 111 and the second active material layer 112 is set a position deviating from the first peak P1.

That is, the maximum thickness t of the first active material layer 111 and the second active material layer 112 is set on the second distance C of a region where the thickness of the first active material layer 111 increases. Thus, it is possible to prevent the sum of the thickness of the first active material layer 111 and the thickness of the second active material layer 112 from increasing in a region of the second distance C, excluding the first distance B. As a result, before pressing the first active material layer 111 and the second active material layer 112, rising of the coating layer in the vicinity of the first start end S1 and the second start end S2 may be minimized or prevented.

Referring to FIG. 3, it is illustrated that graphite particles GP among the first active material and the second active material are uniformly distributed in the first active material layer 111 and the second active material layer 112 formed through the first step ST1 and the second step ST2. The distribution of the graphite particles GP is conceptually illustrated. In addition, the graphite particles GP are merely an example of active materials, and the distribution of particles of other materials may also be regarded as being conceptually similar to the distribution of the graphite particles GP.

In this case, the first active material layer 111 and the second active material layer 112 maintain a reference height h formed by coating in the first step ST1 and the second step S2, before pressing. The reference height h is lower than the maximum thickness t. The maximum thickness t is formed due to rising of the coating layer in the vicinity of the first start end S1 and the second start end S2.

Referring to FIG. 2 to FIG. 4, in a third step ST3, the coating layer, that is, the first active material layer 111 and the second active material layer 112 are pressed. That is, in the third step ST3, the sum of a thickness of the first peak P1 of the first active material layer 111 and a thickness of the second peak P2 of second active material layer 112 is pressed to a maximum of 15 μm. Accordingly, the thickness sum of the first peak P1 of the first active material layer 111 and the second peak P2 of the second active material layer 112 in the completed electrode plate is a maximum of 15 μm. In this case, a thickness sum of the pressed first active material layer 111 and the pressed second active material layer 112 is a pressed height hp formed after the pressing in the third step ST3, and is lower than the reference height h. That is, after the pressing, the thickness sum of the the first and second active material layers 111 and 112 prevent formation of a rising portion h11 (refer to a comparative example) which protrudes higher than the reference height h after being pressed. In the embodiments, a rising portion U is lower than the reference height h.

Referring to FIG. 4, it is illustrated that as an example among the first active material and the second active material, graphite particles GP are pressed and uniformly distributed on the first active material layer 111 and the second active material layer 112 formed in the third step ST3.

After the pressing in the third step ST3, as an example among the first active material particle and the second active material particle, graphite particles GP in the rising portion U have the density higher than the density in other portions such that the porosity is decreased.

Since the decrease of porosity is minimized as the sum of the thickness of the first active material layer 111 and the thickness of the second active material layer 112 in the rising portion U is prevented from being higher than the reference height h, an occurrence of a non-impregnated region into which the electrolyte for electrochemical reaction cannot penetrate between the electrode substrate 101 and the first and second active materials of the first and second active material layers 111 and 112 can be prevented.

Since the non-impregnated region is not generated in the rising portion U of the first active material layer 111 and the second active material layer 112 and an impregnated region is formed over the entire region of the first active material layer 111 and the second active material layer 112, lithium precipitation during charging and discharging may be prevented.

FIG. 5 is a cross-sectional view of the distribution of graphite particles included in a first active material layer and a second active material layer in an electrode plate for a lithium rechargeable battery according to a comparative example, and FIG. 6 is a cross-sectional view of the distribution of the graphite particles included in the first active material layer and the second active material layer in a state that the electrode plate for a lithium rechargeable battery of FIG. 5 is pressed.

For convenience, referring to FIG. 5 and FIG. 6, together with FIG. 2, in a second step of a comparative example, coating of a first active material and a second active material from a start end S12 where the same start end S12 is disposed is started in the proceeding direction of the coating, thereby forming a second active material layer 212 on a first active material layer 211.

Accordingly, the second active material layer 212 is formed on a electrode substrate 101 from the start end S12 in the same manner as a first active material layer 211. That is, the second active material layer 212 is formed over then entire region in which the first active material layer 211 is formed when viewed in the coating direction, and is not formed further on the electrode substrate 101 than the first active material layer 211. That is, the comparative example does not have a configuration corresponding to the section A of the embodiments.

The first active material layer 211 is provided with the start end S12 and a first peak P11, and the second active material layer 212 is provided with the start end S12 and a second peak P12. That is, the first active material layer 211 and the second active material layer and 212 have the same start end S12.

In this case, the first peak P11 of the first active material layer 211 and the second peak P12 of the second active material layer 212 maintain a first distance B1 therebetween in the coating proceeding direction. The first distance B1 is formed rearwardly of the start end S12 in the proceeding direction. The first distance B1 is formed between the first peak P11 of the first active material layer 211 and the second peak P12 of the second active material layer 21, and is disposed rearwardly of the start end S12.

Since the first active material layer 211 and the second active material layer and 212 have the same start end S12 in the comparative example, a section where the second active material layer 212 is further formed than the first active material layer 211 does not exist on the electrode substrate 101. Accordingly, in the comparative example, the first peak P11 of the first active material layer 211 and the second peak P12 of the second active material layer 212 maintain the first distance B1 therebetween in the coating direction

As a result, since the first peak P11 and the second peak P12 substantially overlap or a disposed adjacent to each other rearwardly of the start end S12, a maximum thickness t1 of the first active material layer 211 and the second active material layer and 212 is formed. Accordingly, the sum of a thickness of of the first active material layer 211 and a thickness of the second active material layer and 212 is increased. A rising portion h11 may be formed significantly before pressing the first active material layer 211 and the second active material layer and 212.

Referring to FIG. 5, it is illustrated that graphite particles GP among a first active material and a second active material are uniformly distributed in the first active material layer 211 and the second active material layer and 212 formed in the first step and the second step. The distribution of the graphite particles GP is conceptually illustrated. In addition, the graphite particles GP are an example of active materials, and the distribution of other material particles may also be regarded as being conceptually similar to the distribution of the graphite particles GP.

In this case, the first active material layer 211 and the second active material layer 212 maintain a reference height h formed by coating in the first and second steps and before pressing. The reference height h is lower than the maximum thickness t1 (h<t1). However, even after pressing, a rising portion h11 that protrudes higher than the reference height h is formed the first active material layer 211 and the second active material layer 212 (h11>h).

In the comparative example, after the pressing, the density of active material particles, for example, graphite particles GP of the rising portion h11 formed in the vicinity of the first and second peaks P11 and P12 of the first, second active material layers 211 and 212 becomes higher than the density of the embodiments such that the porosity is greatly decreased.

Since the decrease of the porosity is minimized as the sum thickness in the rising portion h11 in the vicinity of the first and second peaks P11 and P12 of the first and second active material layer 211 and 212 is significantly increased, a non-impregnated region into which an electrolyte for electrochemical reaction cannot penetrate between the electrode substrate 101 and the first and second active materials of the first and second active material layers 111 and 112 may be formed.

In the completed electrode plate of the comparative example, the sum thickness of the first peak P11 of the first active material layer 211 and the second peak P12 of the second active material layer 212 is 20 to 40 μm at maximum. In this case, the pressed first and second active material layers 211 and 212 have a press height hp, which is lower than the reference height h. However, even in this case, the rising portion h11 maintain to be higher than the reference height h due to the maximum thickness t1.

Accordingly, in the completed electrode plate, a non-impregnated region into which an electrolyte for electrochemical reaction cannot penetrate may be formed in a portion exceeding 15 μm in the sum thickness of 20 to 40 μm of the first peak P11 of the first active material layer 211 and the second peak P12 of the second active material layer 212. During charging and discharging, lithium may be precipitated in the non-impregnated region.

### Lithium Rechargeable Battery

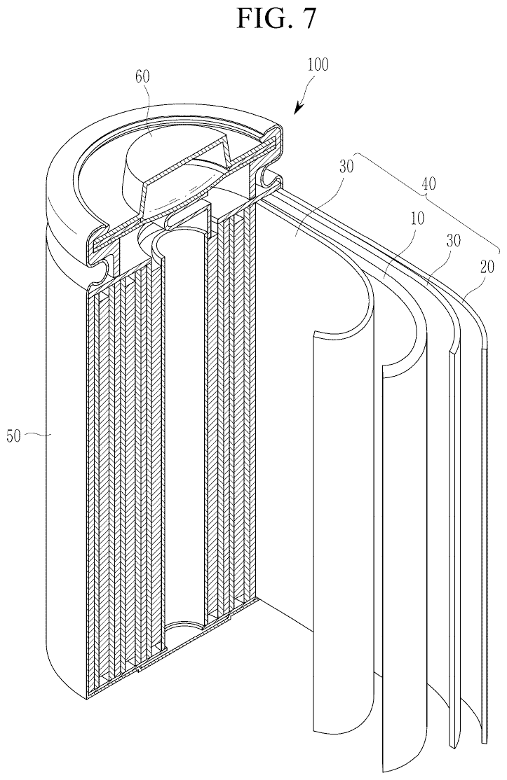

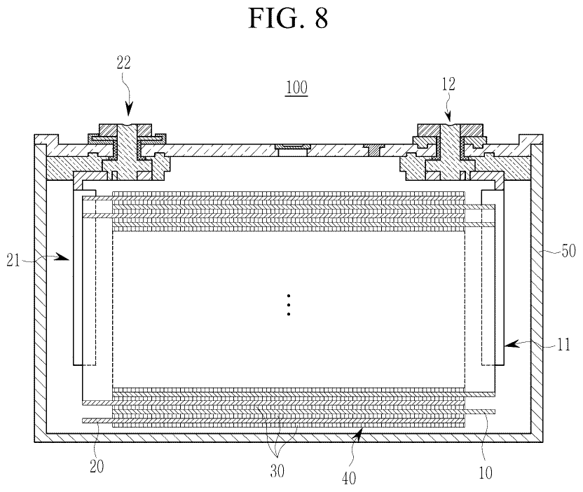

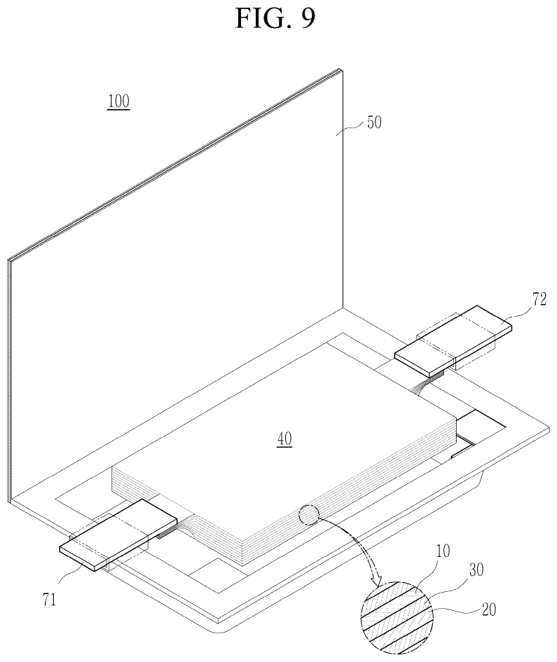

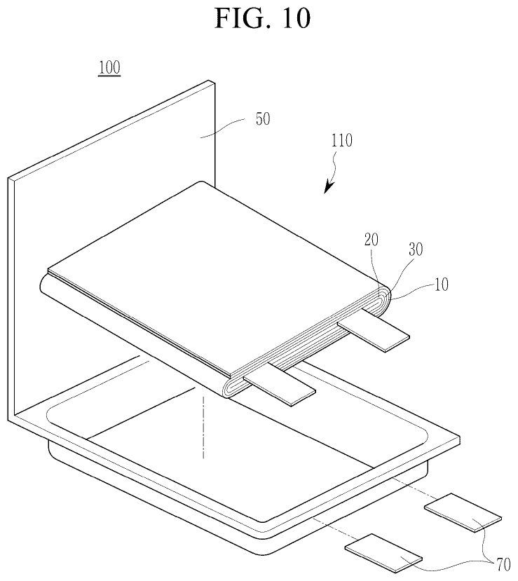

A lithium rechargeable battery may be classified into a cylindrical type battery, a prismatic type battery, a pouch type battery, a con type battery, and the like depending on its shape. FIG. 7 to FIG. 10 are schematic diagrams of a lithium rechargeable battery according to embodiments, and FIG. 7 shows a cylindrical lithium rechargeable battery, FIG. 8 shows a prismatic lithium rechargeable battery, and FIG. 9 and FIG. 10 show a pouch-type lithium rechargeable battery.

Referring to FIG. 7 to FIG. 10, a lithium rechargeable battery 100 may include an electrode assembly 40 including a positive electrode 10, a negative electrode 20, and a separator 30 disposed between the positive electrode 10 and the negative electrode 20, and a case 50 in which the electrode assembly 40 is installed. The positive 10, the negative electrode 20, and the separator 30 may be impregnated with an electrolyte (not shown).

As shown in FIG. 7, the lithium rechargeable battery 100 may include a sealing member 60 that seals the case 50. In addition, in FIG. 8, the lithium rechargeable battery 100 may include a positive electrode lead tab 11, a positive electrode terminal 12, a negative electrode lead tab 21, and a negative electrode terminal 22.

As shown in FIG. 9 and FIG. 10, the lithium rechargeable battery 100 may include an electrode tab 72, that is, a positive electrode tab 71 and a negative electrode tab 72, which serve as electrode passages for guiding a current formed in the electrode assembly 40 to the outside.

In addition, electrode substrates 101 and 201 that do not generate burrs at the positive electrode 10 and the negative electrode 20 are as described above. The electrode assembly 40 and the lithium rechargeable battery 100 according to embodiments of the present disclosure includes the positive electrode and the negative electrode formed of the electrode substrates 101 and 201, and may be applied to a vehicle, a mobile phone, and/or various types of electric devices, but the present disclosure is not limited thereto.

While the present disclosure has been described with reference to preferred embodiments, the present disclosure is not limited thereto, and various modifications and changes may be made without departing from the spirit and scope of the present disclosure as defined by the appended claims, the detailed description, and the accompanying drawings, and such modifications and changes are also intended to fall within the scope of the present disclosure.

What is claimed is:

1. An electrode plate for a lithium rechargeable battery, comprising:
an electrode substrate;
a first active material layer formed by coating a first active material forwardly from a first start end on the electrode substrate; and
a second active material layer formed on the first active material layer by coating a second active material frontwardly from a second start end disposed at a distance rearwardly by a predetermined section from the first start end in a proceeding direction of the coating.

2. The electrode plate for a lithium rechargeable battery as claimed in claim 1, wherein:
the second active material layer is coated on the electrode substrate in a section between the first start end and the second start end.

3. The electrode plate for a lithium rechargeable battery as claimed in claim 1, wherein:
a first distance is formed between a first peak of the first active material layer and a second peak of the the second active material layer in the proceeding direction.

4. The electrode plate for a lithium rechargeable battery as claimed in claim 1, wherein:
the first distance is disposed frontwardly of the first start end in the proceeding direction.

5. The electrode plate for a lithium rechargeable battery as claimed in claim 4, wherein:
the first distance is disposed between the first start end of the first active material layer and the first peak of the first active material layer.

6. The electrode plate for a lithium rechargeable battery as claimed in claim 4, wherein:
a second peak of the second active material layer is disposed within a second distance defined between the start end and the first peak of the first active material layer in the proceeding direction.

7. The electrode plate for a lithium rechargeable battery as claimed in claim 1, wherein:
a sum of a thickness of a first peak of the first active material layer and a thickness of a second peak of the second active material layer is 15 μm at maximum.

8. The electrode plate for a lithium rechargeable battery as claimed in claim 1, wherein:
the first active material layer and the second active material layer are formed in an intermittent pattern.

9. An electrode assembly for a lithium rechargeable battery, comprising the electrode plate for a lithium rechargeable battery as claimed in claim 1.

10. A lithium rechargeable battery comprising the electrode plate for a lithium rechargeable battery as claimed in claim 1.

11. A method for manufacturing an electrode plate for a lithium rechargeable battery, comprising:
a first step in which a first active material layer is formed by coating a first active material frontwardly from a first start end on an electrode substrate;
a second step in which a second active material layer is formed on the first active material layer by a second active material from a second start end disposed rearwardly from the first start end in a proceeding direction of the coating; and
pressing the first active material layer and the second active material layer.

12. The method for manufacturing the electrode plate for a lithium rechargeable battery as claimed in claim 11, wherein:
in the second step, the second active material layer is coated on the electrode substrate in a section between the first start end and the second start end.

13. The method for manufacturing the electrode plate for a lithium rechargeable battery as claimed in claim 11, wherein:
in the second step, a first distance is formed between a first peak of the first active material layer and a second peak of the second active material layer in the proceeding direction.

14. The method for manufacturing the electrode plate for a lithium rechargeable battery as claimed in claim 11, wherein:
in the first step, a first peak of the first active material layer is formed frontwardly of the first start end in the proceeding direction.

15. The method for manufacturing the electrode plate for a lithium rechargeable battery as claimed in claim 14, wherein:
in the second step, a second peak of the second active material layer is disposed within a second distance defined between the start end and the first peak of the first active material layer in the proceeding direction.

16. The method for manufacturing the electrode plate for a lithium rechargeable battery as claimed in claim 11, wherein:
in the third step, a sum of a thickness of a first peak of the first active material layer and a thickness of a second peak of the second active material layer is 15 μm at maximum.
